(19) United States
(12) Patent Application Publication
(10) Pub. No.: US 2009/0204619 A1
(43) Pub. Date: Aug. 13, 2009

(54) Device capable of automatically downloading files and method thereof

(76) Inventor: Cheng-Chun Chang, Hsin-Tien City (TW)

Correspondence Address: Guice Patents PLLC, 12647 Galveston Court #302, Manassas, VA, 20112, US

(21) Appl. No.: 12/081,389

(22) Filed: Apr. 15, 2008

(30) Foreign Application Priority Data
Apr. 18, 2007 (TW) 096113580

(51) Int. Cl. G06F 15/16; G06F 12/00; G06F 12/02; G06F 1/16

(52) U.S. Cl. 707/10; 711/103; 361/679.02; 711/115; 711/E12.001; 711/E12.008

(57) ABSTRACT

The present invention relates to a device capable of automatically downloading files comprises, a printed circuit board; a micro controller; a memory provided with a program; an internet interface for connecting to an internet; and a connecting interface coupled with a hub; when a card reader is coupled with the hub, the micro controller is controlled by the program with respect to a schedule written in a memory card in the card reader so as to connect to the internet via the internet interface and in sequence process relevant operations of downloading files. A method of automatically downloading files is also disclosed by the present invention.

### BACKGROUND OF THE INVENTION

1. Field of the Invention

The present invention relates to a device capable of automatically downloading files and method thereof, more particularly to a device capable of automatically downloading files and method thereof in which a schedule of files to be downloaded is firstly edited by a computer and stored in a memory card then automatic download operations are controlled and processed by a download program.

2. Description of Related Art

When a user wants to download a file via a computer, a P2P (point to point) download program, e.g. a BT, an Emule, a Foxy or a similar program, is often used to download the file after the computer is connected to a desired website via an internet, but a user can also let his computer connect to plural websites for downloading files. When the user is not on site, the above mentioned methods could not be used to download files in real time, in other words a conventional download method requires a computer, and a user has to be on site to process operations of downloading files. This may cause some inconveniences and shall be improved. A device capable of automatically downloading files and method thereof should be invented to overcome the above mention disadvantages.

### SUMMARY OF THE INVENTION

One object of the present invention is to provide a device capable of automatically downloading files and method thereof, wherein a schedule of files to be downloaded is firstly edited by a computer and stored in a memory card then automatic download operations are controlled and processed by a download program.

Another object of the present invention is to provide a device capable of automatically downloading files and method thereof, wherein a user can download files without a computer.

For achieving the objects mentioned above, the device capable of automatically downloading files comprises, a printed circuit board for carrying following units; a micro controller disposed on the printed circuit board; a memory disposed on the printed circuit board and coupled with the micro controller, a program is provided in the memory; an internet interface disposed on the printed circuit board and coupled with the micro controller for connecting to an internet; and a connecting interface disposed on the printed circuit bard and coupled with the micro controller for being coupled with a hub; when a card reader is coupled with the hub, the micro controller is controlled by the program with respect to a schedule written in a memory card in the card reader so as to connect to the internet via the internet interface and in sequence process relevant operations of downloading files.

For achieving the objects mentioned above, the method of automatically downloading files provided by the present invention includes the steps of: a schedule is edited by a computer mainframe and stored in a memory card; the memory card is then inserted into a card reader and the card reader is connected to a hub; a download device having a program is coupled with the hub; the download device is controlled by the program with respect to the schedule so as to connect the download device to an internet and in sequence process relevant operations of downloading files.

### BRIEF DESCRIPTION OF THE DRAWINGS

FIG. 1 is a block diagram of a device capable of automatically downloading files of one preferred embodiment of the present invention;

FIG. 2 is a schematic view of the assembly of the device capable of automatically downloading files provided by the present invention;

FIG. 3 is a schematic view of a user editing a schedule via a computer and storing the schedule in a memory card;

FIG. 4 is a schematic view of the device capable of automatically downloading files provided by the present invention connecting to a card reader and operations of downloading files are processed with respect to the schedule;

FIG. 5 is a flow chart of the method of automatically downloading files provided by the present invention.

### DETAILED DESCRIPTION OF THE PREFERRED EMBODIMENT

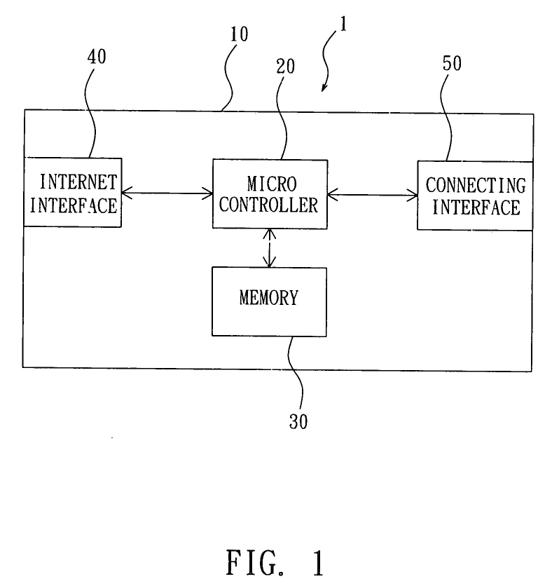

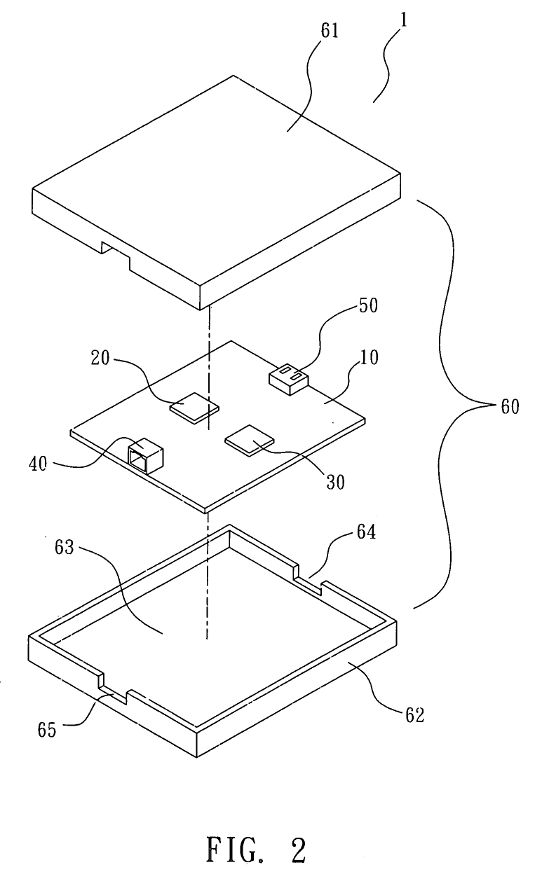

As shown in FIG. 1 and FIG. 2, the device 1 capable of automatically downloading files provided by the present invention, comprises a printed circuit board 10; a micro controller 20; a memory 30; an internet interface 40; and a connecting interface 50.

The printed circuit board 10 is served to carry the micro controller 20, the memory 30, the internet interface 40 and the connecting interface 50.

The micro controller 20 is disposed on the printed circuit board 10 and can be controlled by a program to process operations of downloading files, wherein the micro controller 20 can be a general micro controller or a central processing unit.

The memory 30 is disposed on the printed circuit board 10 and coupled with the micro controller 20, a program (not shown) is written in the memory 30, the program is served to control the micro controller 20 to process relevant operations of downloading files, the program is preferably to be a point-to-point, P2P, download program, e.g. but not limited to a BT, an Emule, a Foxy or a similar download program, and the memory 30 can be, but not limited to, a flash memory.

The internet interface 40 is disposed on the printed circuit board 10 and coupled with the micro controller 20 for connecting to an internet (not shown), and the internet interface 40 can be, but not limited to, a wired or wireless Ethernet or a similar internet.

The connecting interface 50 is disposed on the printed circuit board 10 and coupled with the micro controller 20 for being coupled with a hub 70, wherein the connecting interface 50 can be a USB port or an IEEE 1394 port.

The device 1 capable of automatically downloading files provided by the present invention is further provided with a housing 60, the housing 60 has a top housing member 61 and a bottom housing member 62, and an accommodating space 63 is defined between the top housing member 61 and the bottom housing member 62 for receiving and protecting the printed circuit board 10 and the units carried thereon, one end of the housing 60 is further provided with a plurality of openings 64, 65 for respectively allowing the connecting interface 50 and the internet interface 40 expose outside.

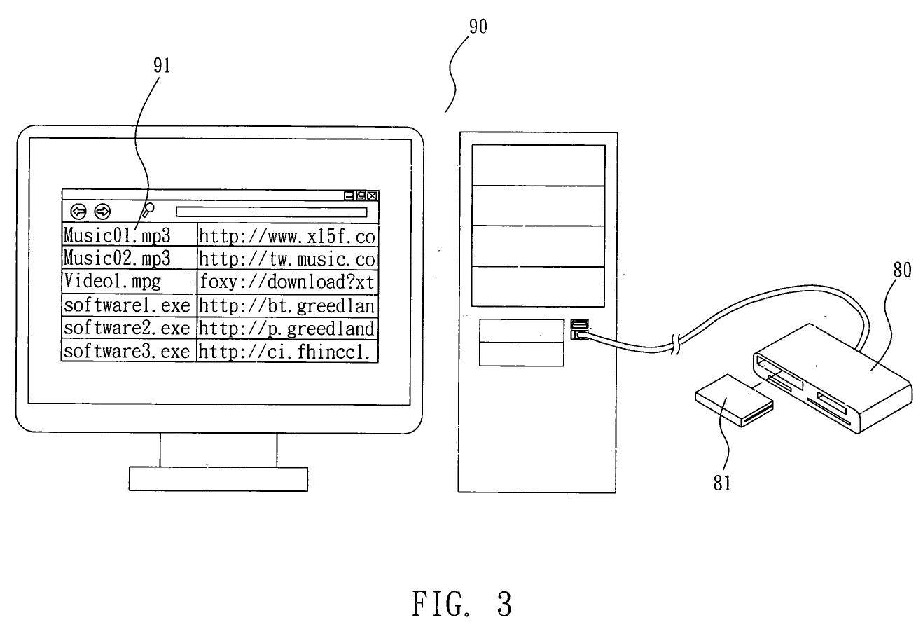

As shown in FIG. 3, a card reader 80 can be connected to a computer mainframe 90 by a user, and a schedule 91 is edited by the computer mainframe 90, a list of files or programs that the user wants to download and web addresses of web sites to be connected are recorded in the schedule 91, then the schedule 91 is stored in a memory card 81 of the card reader 80. The memory card 81 can be a SM, an xD, a CompactFlash I, a CompactFlash II, a MicroDrive, a Memory Stick, a Memory Stick Pro or a Magicstor Drive. A CompactFlash I (CF) memory card in used in this embodiment for illustration but not limited to the CompactFlash I memory card.

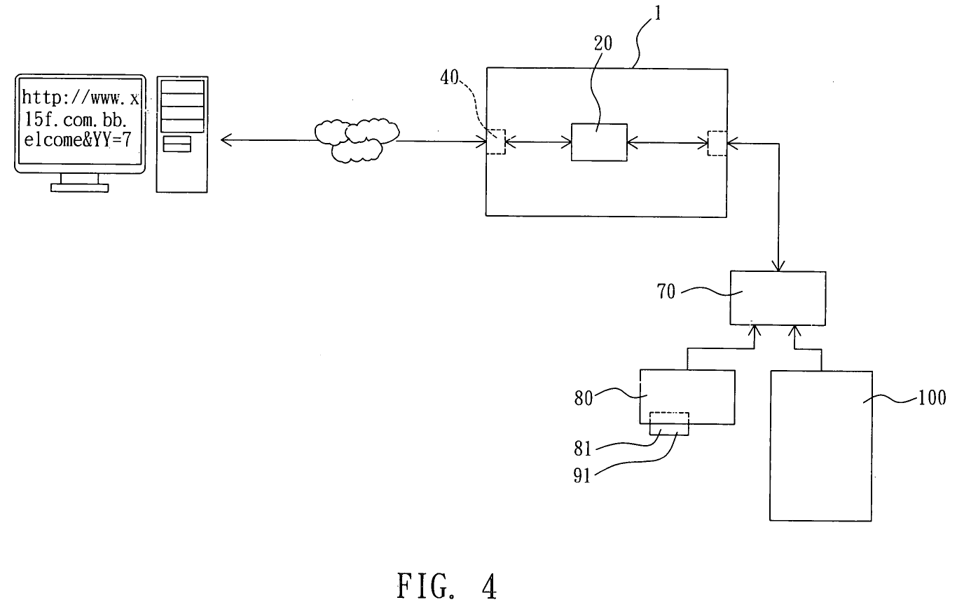

As shown in FIG. 4, when a user wants to download files or programs, the card reader 80 is connected to the hub 70 by the user, then the hub 70 is connected to the device 1 capable of automatically downloading files provided by the present invention, then an internet is accessed via the internet interface 40; the memory card 81 is inserted into the card reader 80 and the schedule 91 in the memory card 81 is detected by the program, then the micro controller 20 is controlled by the program so as to process an operation of internet connection, thus the wed addresses of the websites listed in the schedule 91 are connected so as to process relevant operations of downloading files. With the device 1 capable of automatically downloading files provided by the present invention, relevant operations of downloading files can be processed without a computer and without a user being on side, so the device 1 capable of automatically downloading files provided by the present invention is novel compared to conventional arts.

The device 1 capable of automatically downloading files provided by the present invention can be further provided with an external hard disc 100 coupled with the hub 70 for storing downloaded files or programs.

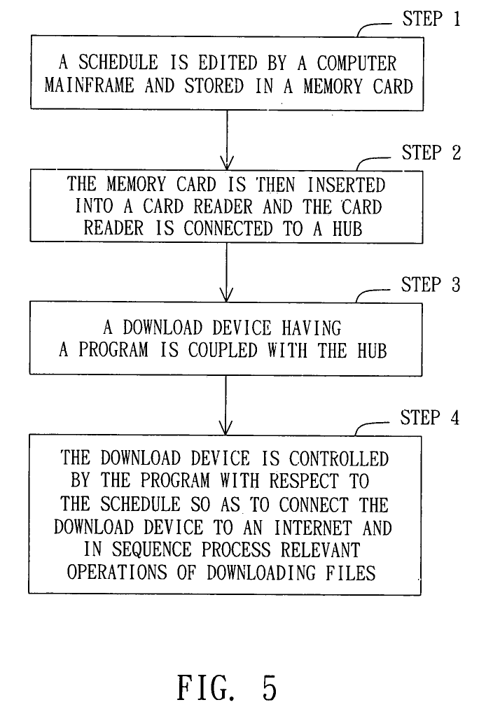

A method of automatically downloading files is also provided by the present invention. Referring to FIG. 5, which is a flow chart of the method of automatically downloading files provided by the present invention. As shown in FIG. 5, the method of automatically downloading files provided by the present invention included the steps of: a schedule 91 is edited by a computer mainframe 90 and stored in a memory card 81 (Step 1); the memory card 81 is then inserted into a card reader 80 and the card reader 80 is connected to a hub 70 (Step 2); a download device 1 having a program is coupled with the hub 70 (Step 3); the download device 1 is controlled by the program with respect to the schedule 91 so as to connect the download device 1 to an internet and in sequence process relevant operations of downloading files (Step 4).

In the Step 1, the schedule 91 is edited by the computer mainframe 90 and stored in the memory card 81; wherein files or programs that a user wants to download and web addresses of web sites to be connected are recorded in the schedule 91; the memory card 81 can be a SM, an xD, a CompactFlash I, a CompactFlash II, a MicroDrive, a Memory Stick, a Memory Stick Pro or a Magicstor Drive.

In the Step 2, the memory card 81 is inserted into the card reader 80, and the card reader 80 is connected to the hub 70; wherein the hub 70 can be a USB port or an IEEE1394 port.

In the Step 3, the download device 1 having a program is coupled with the hub 70; wherein the download device 1 is provided with a printed circuit board 10; a micro controller 20; a memory 30; an internet interface 40; and a connecting interface 50; the program can be a point-to-point (P2P) download program, e.g., but not limited to a BT, an Emule, a Foxy, or any similar program.

In the Step 4, the download device 1 is controlled by the program with respect to the schedule 91 so as to connect the download device 1 to an internet and in sequence process relevant operations of downloading files; wherein the schedule 91 in the memory card 81 is detected by the program, then the micro controller 20 is controlled by the program so as to process an operation of internet connection, thus the wed addresses of the websites recorded in the schedule 91 are connected so as to process relevant operations of downloading files.

With the device capable of automatically downloading files and method thereof provided by the present invention, a schedule of files desired to be downloaded can be edited by a computer and stored in a memory card, then operations of automatically downloading are controlled and processed by a download program.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A device capable of automatically downloading files, comprises:
a printed circuit board for carrying following units;
a micro controller disposed on the printed circuit board;
a memory disposed on the printed circuit board and coupled with the micro controller, a program is provided in the memory;
an internet interface disposed on the printed circuit board and coupled with the micro controller for connecting to an internet; and
a connecting interface disposed on the printed circuit bard and coupled with the micro controller for being coupled with a hub;
when a card reader is coupled with the hub, the micro controller is controlled by the program with respect to a schedule written in a memory card of the card reader so as to connect to the internet via the internet interface and in sequence process relevant operations of downloading file.

2. The device capable of automatically downloading files as claimed in claim 1, wherein the memory is a flash memory, and the program is a point-to-point (P2P) download program.

3. The device capable of automatically downloading files as claimed in claim 2, wherein the point-to-point (P2P) download program is a BT, an Emule, a Foxy, or a similar program.

4. The device capable of automatically downloading files as claimed in claim 1, wherein the internet interface is an Ethernet or a similar internet

5. The device capable of automatically downloading files as claimed in claim 1, wherein the connecting interface is a USB port or an IEEE1394 port.

6. The device capable of automatically downloading files as claimed in claim 1, wherein the memory card is a SM, an xD, a CompactFlash I, a CompactFlash II, a MicroDrive, a Memory Stick, a Memory Stick Pro or a Magicstor Drive.

7. The device capable of automatically downloading files as claimed in claim 1, wherein a list of files or programs that a user wants to download and web addresses of web sites to be connected are recorded in the schedule, then the schedule can be edited by a computer mainframe via the card reader and the memory card.

8. The device capable of automatically downloading files as claimed in claim 1, wherein the device capable of automatically downloading files is further provided with an external hard disc coupled with the hub for storing downloaded files or programs.

9. The device capable of automatically downloading files as claimed in claim 1, wherein the device capable of automatically downloading files is further provided with a housing, the housing has a top housing member and a bottom housing member, and an accommodating space is defined between the top housing member and the bottom housing member for receiving and protecting the printed circuit board and the units carried thereon, one end of the housing is further provided with a plurality of openings for respectively allowing the connecting interface and the internet interface expose outside.

10. A method of automatically downloading files, includes the steps of:
a schedule is edited by a computer and stored in a memory card;
the memory card is then inserted into a card reader and the card reader is connected to a hub;
a download device having a program is coupled with the hub; and
the download device is controlled by the program with respect to the schedule so as to connect the download device to an internet and in sequence process relevant operations of downloading files.

11. The method of automatically downloading files as claimed in claim 10, wherein a list of programs that a user wants to download and web addresses of websites to be connected are recorded in the schedule.

12. The method of automatically downloading files as claimed in claim 10, wherein the memory card is a SM, an xD, a CompactFlash I, a CompactFlash II, a MicroDrive, a Memory Stick, a Memory Stick Pro or a Magicstor Drive.

13. The method of automatically downloading files as claimed in claim 10, wherein the program is a point-to-point (P2P) download program.

14. The method of automatically downloading files as claimed in claim 10, wherein the point-to-point (P2P) download program is a BT, an Emule, a Foxy, or a similar program.

15. The method of automatically downloading files as claimed in claim 10, wherein the download device comprises:
a printed circuit board for carrying following units;
a micro controller disposed on the printed circuit board;
a memory disposed on the printed circuit board and coupled with the micro controller, a program is provided in the memory;
an internet interface disposed on the printed circuit board and coupled with the micro controller for connecting to an internet; and
a connecting interface disposed on the printed circuit bard and coupled with the micro controller for being coupled with a hub.

16. The method of automatically downloading files as claimed in claim 15, wherein the memory is a flash memory, the internet interface is an Ethernet or a similar internet, and the connecting interface is a USB port or an IEEE1394 port.
